(19) United States
(12) Patent Application Publication
(10) Pub. No.: US 2008/0164856 A1
(43) Pub. Date: Jul. 10, 2008

(54) CURRENT SENSING CIRCUIT AND POWER SUPPLY USING THE SAME

(75) Inventors: Hsu-Min Chen, Hsinchu City (TW); Yi-Chung Chou, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: ITE TECH. INC., Hsinchu (TW)

(21) Appl. No.: 11/682,881

(22) Filed: Mar. 7, 2007

(30) Foreign Application Priority Data
Jan. 8, 2007 (TW) 96100683

(51) Int. Cl. G05F 1/573

(52) U.S. Cl. 323/277; 324/769

(57) ABSTRACT

A current sensing circuit and power supply using the same are provided. The current sensing circuit includes a transistor, a control circuit and a sensing circuit, wherein the voltage endurance capability between a drain terminal of the transistor and a gate of the transistor is larger than the voltage endurance capability between a source terminal of the transistor and the gate of the transistor. The drain terminal is coupled to an under testing current source with an external high voltage. The control circuit is coupled to the gate of the transistor to control the conduction between the drain and the source terminals. The sensing circuit receives a sensing current signal from the source terminal of the transistor and transfers thereof to be a current sensing voltage.

### CROSS-REFERENCE TO RELATED APPLICATION

This application claims the priority benefit of Taiwan application serial no. 96100683, filed on Jan. 8, 2007. All disclosure of the Taiwan application is incorporated herein by reference.

### BACKGROUND OF THE INVENTION

1. Field of the Invention

The present invention generally relates to a power electronic technology, in particular, to a current sensing circuit and a power supply using the same.

2. Description of Related Art

With the rapid developments of information and communication equipments, design of a switching power supply with high efficiency has been science with the combination of engineering and experience. Switching power supplies are used in many devices, e.g. computers, illumination converters and telecom devices, to switch power thereof. Usually, there are two kinds of feedback mechanisms for switching power supplies, one of which is voltage feedback, and the other one is current feedback. The current feedback is a feedback mechanism that takes a current as an output parameter, and it has been proved to have better characteristics than those of the voltage feedback mechanism because of its larger frequency, larger dynamic and linear ranges, smaller power consumption and simpler circuit designs.

A power supply usually includes a conversion circuit and a switch controlling circuit, wherein the conversion circuit includes at least one switch element, and the on/off states of the switch element are controlled by the switch controlling circuit. In such a way, an input voltage of the conversion circuit is transferred to be an output voltage as desired. The current feedback circuit is built in the switch controlling circuit. With improvements on integrated circuit technology, the switch element of the conversion circuit is nowadays often integrated into the switch controlling circuit so as to save the layout space and the cost of the circuit board. However, in case the power supply needs to transfer the input voltage to be an output voltage that higher than the input voltage and the switch element is integrated into the switch controlling circuit, the integrated switch element has to be manufactured in a high voltage process in order to avoid an internal circuit thereof being damaged.

Usually, a transistor made in a high-voltage process, has high voltage endurance capability between a drain terminal and a gate of the transistor and between a source terminal and the gate of the transistor. However, ion implantation concentrations in the drain and source terminals of such kind of transistor are decreased inevitably, which leads to the disadvantage that the on-resistance thereof is increased. Furthermore, the cost of the transistor made in a high-voltage process is high. Hence, using the transistor made in the high-voltage process reduces operation efficiency of a circuit inevitably and at the same time increases the cost of the circuit.

### SUMMARY OF THE INVENTION

Accordingly, the present invention is directed to a current sensing circuit for detecting a current with an external current source when a voltage of the external current source is higher than a supply voltage of an internal integrated circuit.

The present invention is also directed to a power supply for detecting a current of an external current source, as a feedback mechanism to control an output voltage of the power supply.

According to an embodiment of the present invention, a current sensing circuit is provided. The current sensing circuit comprises a half high-voltage transistor, a controlling circuit and a sensing circuit, wherein the voltage endurance capability between a drain terminal of the half high-voltage transistor and a gate of the half high-voltage transistor is larger than the voltage endurance capability between a source terminal of the half high-voltage transistor and the gate of the half high-voltage transistor. The drain terminal is coupled to an under testing current source with an external high voltage. The control circuit is coupled to the gate of the half high-voltage transistor to control the conduction between the drain and the source terminal. The sensing circuit receives a sensing current signal from the source terminal of the half high-voltage transistor and transfers the sensing current signal to be a current sensing voltage.

According to another embodiment of the present invention, a power supply is provided. The power supply comprises a magnetic element, a half high-voltage transistor, a controlling circuit and a sensing circuit. An end of the magnetic element is coupled to an input voltage. The voltage endurance capability between a drain terminal of the half high-voltage transistor and a gate of the half high-voltage transistor is larger than the voltage endurance capability between a source terminal of the half high-voltage transistor and the gate of the half high-voltage transistor. The drain terminal is coupled to the other end of the magnetic element. The control circuit is coupled to the gate of the, half high-voltage transistor to control the conduction between the drain and the source terminal. The sensing circuit receives a sensing current signal from the source terminal of the half high-voltage transistor and transfers the sensing current signal to be a current sensing voltage.

According to a preferred embodiment of the present invention of the current sensing circuit and the power supply, the sensing circuit comprises a current mirroring circuit and a first resistance element. The current mirroring circuit is used to decrease the sensing current signal by a predetermined rate to output a ratio current from a current output node. The first resistance element is coupled between the current output node and a first common voltage and generates the current sensing voltage based on the ratio current.

According to a preferred embodiment of the present invention of the current sensing circuit and the power supply, the controlling circuit is provided to output a control signal to control the conduction between the drain and the source terminals of the half high-voltage transistor, and the current mirroring circuit comprises a first transistor, a second transistor, a third transistor, a forth transistor, a fifth transistor, a sixth transistor and an amplifier. The first source/drain terminal of the first transistor is coupled to the drain terminal of the half high-voltage transistor, the second source/drain terminal of the first transistor is coupled to the first common voltage, and the gate of the first transistor receives the control signal. A negative end of the amplifier is coupled to the source terminal of the half high-voltage transistor. The gate of the second transistor receives a reverse control signal reversed to the control signal, the first source/drain terminal of the second transistor is coupled to the negative end of the amplifier, and the second source/drain terminal of the second transistor is coupled to the first common voltage. The gate of the third transistor receives the reverse control signal, the first source/drain terminal of the third transistor is coupled to a positive end of the amplifier, and the second source/drain terminal is coupled to the first common voltage. The gate of the forth transistor receives the control signal, the first source/drain terminal of the forth transistor is coupled to the positive end of the amplifier, and the second source/drain terminal of the forth transistor is coupled to the first common voltage. The gate of the fifth transistor is coupled to an output end of the amplifier, the first source/drain terminal of the fifth transistor is coupled to a second common voltage, and the second source/drain terminal of the fifth transistor is coupled to the positive end of the amplifier. The gate of the sixth transistor is coupled to the output end of the amplifier, the first source/drain terminal of the sixth transistor is coupled to the second common voltage, and the second source/drain terminal of the sixth transistor is coupled to the current output node.

According to a preferred embodiment of the present invention of the current sensing circuit and the power supply, the current mirroring circuit further comprises a current source for outputting a bias current to the source terminal of the half high-voltage transistor.

According to a preferred embodiment of the present invention of the current sensing circuit and the power supply, a protection circuit for preventing a current of the source terminal of the half high-voltage transistor from being too high to damage the sensing circuit, is further provided between the half high-voltage transistor and the sensing circuit. In this embodiment, the protection circuit comprises a second resistance element and a third resistance element. A first end of the second resistance element is coupled to the half high-voltage transistor, and a second end of the second resistance element is coupled to the sensing circuit. A first end of the third resistance element is coupled to said second end of the second resistance element, and a second end of the third resistance element is coupled to a first common potential.

According to a preferred embodiment of the present invention of the power supply, the magnetic element is an inductor or a transformer.

In the present invention, the transistor in the current sensing circuit is made in a half high-voltage process, the drain and source terminals thereof are channels that the sensing current signal goes through inevitably, and the drain and source terminals are reversely coupled, so that the source terminal receives the under testing current source with the external high voltage. In such a way, damages to the transistor and the controlling circuit coupled to the gate of the transistor can be avoided, and the on-resistance (R_{ds}-on) of the transistor made in a half high-voltage process is far less than that of a transistor made in the whole high-voltage process. Accordingly, the manufacture cost of a semiconductor circuit according to the present invention can be reduced, and operation efficiency of the circuit can be significantly improved.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a circuit diagram of a power supply according to an embodiment of the present invention.

FIG. 2 is a cross-section view of a semiconductor of a half high-voltage transistor 101 according to an embodiment of the present invention.

FIG. 3 is a circuit diagram of the current sensing circuit 10 according to another embodiment of the present invention.

FIG. 4 is a circuit diagram of the power supply according to further another embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

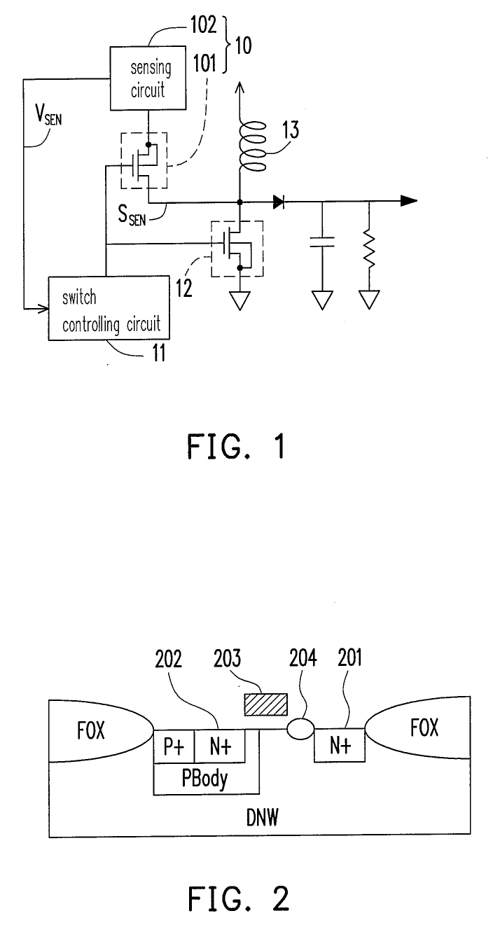

FIG. 1 is a circuit diagram of a power supply according to an embodiment of the present invention. Referring to FIG. 1, the power supply in this embodiment takes a boost circuit as an example for illustrative purpose. The power supply comprises a current sensing circuit 10, a switch controlling circuit 11, a switch element 12 and a magnetic element 13. The current sensing circuit 10 comprises a half high-voltage transistor 101 and a sensing circuit 102. In this embodiment, the current sensing circuit 10 is designed mainly for detecting the current flowing through the magnetic element 13 and-taken as a reference to the feedback control of the switch controlling circuit 11. For instance, based on the current feedback, the switch controlling circuit 11 is able to control the on and off states of the switch element 12, and an output voltage of the boost circuit according to this embodiment is accordingly stabilized.

The drain terminal of the half high-voltage transistor 101 of this embodiment is coupled to the magnetic element 13, and receives a sensing current signal S_{SEN} which represents a current flowing through the magnetic element 13. The sensing current signal S_{SEN} is converted into a sensing voltage V_{SEN} by the sensing circuit 102. Based on the sensing voltage V_{SEN}, the switch controlling circuit 11 controls the on and off states of the half high-voltage transistor 101 and the switch element 12. When an output voltage of the boost circuit is so high that exceeds the voltage endurance limit of the current sensing circuit, however the half high-voltage transistor 101 made in a half high-voltage process as illustrated in FIG. 2 will not be damaged. In FIG. 2, the numeral references 201, 202, 203 indicate the drain terminal, the source terminal and the gate of the half high-voltage transistor 101, respectively. The numeral reference P+ indicates the P+ ion implantation, the numeral reference N+ indicates N+ ion implantation, the numeral reference PBody indicates a P well, the numeral reference DNW indicates a deep N well, and the numeral reference 204 indicates an oxidization layer.

As shown in FIG. 2, the voltage endurance capability between the drain terminal 201 and the gate 203 of the transistor 101 obtained by this kind of process is very high (it is usually able to endure a voltage of 40V), while the voltage endurance capability between the source terminal 202 and the gate 203 thereof is very low (generally it's 5V), and the on-resistance between the source terminal 202 and the gate 203 is far less than that of a transistor wholly made in a high-voltage process. Therefore, the operation efficiency of the current sensing circuit 10 is increased. Furthermore, even if the voltage with the magnetic element 13 exceeds its voltage endurance limit, the junction between the drain terminal 201 and the gate 203 will not break down because of the high voltage endurance capability between the drain terminal 201 and the gate 203. Hence, damages to switch controlling circuit 11 caused by an external high voltage can be avoided.

The embodiment as illuminated above takes the boost circuit as the example, but a person skilled in the art should know that the current sensing circuit 10 of the present invention can be used to detect a current of an external current source when the voltage of the external current source is larger than a supply voltage of an internal integrated circuit. Hence, the boost circuit is only taken as one example to illuminate the spirit of the present invention, and it's not intended to limit the invention in any way, e.g. the applications of the present invention should not be limited. It shall be apparent to those skilled in the art that applying the spirits of the present invention to various topologies, e.g. duck-boost circuits and flyback circuits, by the motivations and teachings of the embodiments as illuminated above.

To enable a person skilled in the art to understand the invention further, other exemplary embodiments will be illuminated below.

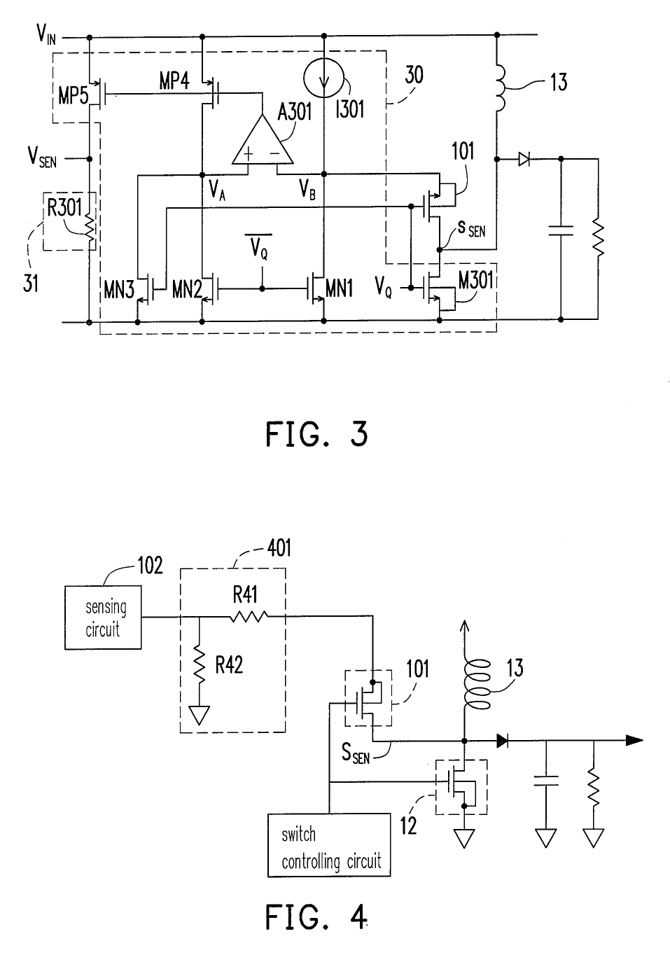

FIG. 3 is a circuit diagram of the current sensing circuit 10 of FIG. 1. As shown in FIG. 3, the circuit comprises a current mirroring circuit 30 and a resistance element 31. The current mirroring circuit 30 comprises an amplifier A301, transistors MN1˜MN3, MP4, MP5, a current source I301, and a switching transistor M301. The switching transistor M301 is a preferred embodiment of the switch element 12 as illuminated in the embodiment illustrated in FIG. 1. The switching transistor M301 is made by a half high-voltage process like that the half high-voltage transistor 101 is made. The resistance element 31 is embodied as a resistor R301. In addition, the gates of the transistors M301, MN3 and 101 are coupled to the switch controlling circuit, and receive a control signal V_{Q} outputted from the switch controlling circuit. The transistors MN1, MN2 receive a reverse control signal V̅_̅{̅Q̅}̅ reversed to the control signal V_{Q}.

When the control signal V_{Q} is at high potential, the transistors M301, 101 and MN3 is in on states, and the transistors MN1 and MN2 is in off states. The current IL flowing through the inductor 13 flows totally through the switching transistor M301, and the current I₁ generated by the current source I301 flows through the transistors 101 and M301, thereby a sensing current signal S_{SEN} relevant to the current I_{L} is generated between the source and drain terminals of the transistor M301. The sensing current signal S_{SEN} is transmitted to the source terminal of the half high-voltage transistor 101 via the drain terminal of the half high-voltage transistor 101, and then it arrives at a negative end of the amplifier A301. The voltage at a negative end of the amplifier A301 is V_{B} at this moment. The voltage V_{A} at a positive end of the amplifier A301 is deemed to be equal to V_{B} because voltages at the positive and negative ends of an ideal amplifier are equal.

Since V_{A} is equal to V_{B}, and being V_{Q}, the gate voltages of the transistor MN3 and M301 are equal, the current flowing through the transistor MN3 is in ratio relationship with that flowing through the transistor M301. In addition, the current flowing through the transistor MP4 is equal to that flowing through the transistor MN3, therefore the current flowing though the transistor MP4 is in ratio relationship with that flowing through the transistor MP5. Finally, the current flowing through the transistor MP5 flows through the resistor R301 to obtain a sensing voltage V_{SEN} that is relevant to the current I_{L} flowing through the inductor 13. In such a way, the object to detect the current of the external current source when the voltage of the external current source is larger than the supply voltage of the internal integrated circuit is achieved.

FIG. 4 is a circuit diagram according to a further embodiment of the present invention. Referring to FIG. 4, the difference between this circuit and that as illustrated in FIG. 1 is that in this embodiment there is further provided a protection circuit 401 between the half high-voltage transistor 101 and the sensing circuit 102. In this embodiment, the protection circuit 401 is carried out by resistors R41 and R42. Since that is the current of the magnetic element 13 to be detected, it is possible that the drain terminal of half high-voltage transistor 101 receives a very high voltage spike when it's conducted. The voltage spike might destroy the sensing circuit 102. Therefore the resistors R41 and R42 are provided as voltage dividers between the sensing circuit 102 and the half high-voltage 101 to prevent damages to the sensing circuit 102.

In summary, the transistor in the current sensing circuit is made in the half high-voltage process, wherein the drain and source terminals of the transistor are channels that the under testing sensing current signal flows through inevitably, and the drain terminal thereof reversely coupled to the source terminal receives the under testing current source with the external high voltage. In such a way, damages to the transistor and the control circuit coupled to the gate of the transistor can be avoided, and furthermore the on-resistance (R_{ds}-on) of the transistor made in the half high-voltage process is far less than that of a transistor made by a whole high-voltage process. Hence, the manufacture cost of a semiconductor circuit according to the present invention can be reduced, and operation efficiency of the circuit can be significantly improved.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A current sensing circuit, comprising:
a half high-voltage transistor, the voltage endurance capability between a drain terminal of the half high-voltage transistor and a gate of the half high-voltage transistor being larger than the voltage endurance capability between a source terminal of the half high-voltage transistor and the gate of the half high-voltage transistor, the drain terminal of the half high-voltage transistor being coupled to an under testing current source with an external high voltage;
a controlling circuit coupled to the gate of the half high-voltage transistor to control the conduction between the drain and the source terminals; and
a sensing circuit receiving a sensing current signal from the source terminal of the half high-voltage transistor and transferring the sensing current signal to be a current sensing voltage.

2. The current sensing circuit according to claim 1, wherein the sensing circuit comprises:
a current mirroring circuit for decreasing the sensing current signal by a predetermined rate to output a ratio current from a current output node; and
a first resistance element coupled between the current output node and a first common voltage and generating the current sensing voltage based on the ratio current.

3. The current sensing circuit according to claim 2, wherein the controlling circuit is provided for outputting a control signal to control the conduction between the drain terminal o the half high-voltage transistor and the source terminal of the half high-voltage transistor, and the current mirroring circuit comprises:
an amplifier, a negative end thereof being coupled to the source terminal of the half high-voltage transistor;
a first transistor, the first source/drain terminal of the first transistor being coupled to the drain terminal of the half high-voltage transistor, the second source/drain terminal of the first transistor being coupled to the first common voltage, and the gate of the first transistor receiving the control signal;
a second transistor, the gate of the second transistor receiving a reverse control signal reversed to the control signal, the first source/drain terminal of the second transistor being coupled to the negative end of the amplifier, and the second source/drain terminal of the second transistor being coupled to the first common voltage;
a third transistor, the gate of the third transistor receiving the reverse control signal, the first source/drain terminal of the third transistor being coupled to a positive end of the amplifier, and the second source/drain terminal being coupled to the first common voltage;
a forth transistor, the gate of the forth transistor receiving the control signal, the first source/drain terminal of the forth transistor being coupled to the positive end of the amplifier, and the second source/drain terminal of the forth transistor being coupled to the first common voltage;
a fifth transistor, the gate of the fifth transistor being coupled to an output end of the amplifier, the first source/drain terminal of the fifth transistor being coupled to a second common voltage, and the second source/drain terminal of the fifth transistor being coupled to the positive end of the amplifier; and
a sixth transistor, the gate of the sixth transistor being coupled to the output end of the amplifier, the first source/drain terminal of the sixth transistor being coupled to the second common voltage, and the second source/drain terminal of the sixth transistor being coupled to the current output node.

4. The current sensing circuit according to claim 3, wherein the current mirroring circuit further comprises a current source for outputting a bias current to the source terminal of the half high-voltage transistor.

5. The current sensing circuit according to claim 1, wherein a protection circuit for preventing a current of the source terminal of the half high-voltage transistor from being too high to damage the sensing circuit, is further provided between the half high-voltage transistor and the sensing circuit.

6. The current sensing circuit according to claim 5, wherein the protection circuit comprises:
a second resistance element, a first end of the second resistance element being coupled to the half high-voltage transistor, and a second end of the second resistance element being coupled to the sensing circuit; and
a third resistance element, a first end of the third resistance element being coupled to the second end of the second resistance element, and a second end of the third resistance element being coupled to a first common potential.

7. A power supply, comprising:
a magnetic element, an end of the magnetic element being coupled to an input voltage;
a half high-voltage transistor, the voltage endurance capability between a drain terminal of the half high-voltage transistor and a gate of the half high-voltage transistor being larger than the voltage endurance capability between a source terminal of the half high-voltage transistor and the gate of the half high-voltage transistor, the drain terminal of the half high-voltage being coupled to the other end of the magnetic element;
a controlling circuit coupled to the gate of the half high-voltage transistor to control the conduction between the drain and the source terminal; and
a sensing circuit receiving a sensing current signal from the source terminal of the half high-voltage transistor and transferring the sensing current signal to be a current sensing voltage.

8. The power supply according to claim 7, wherein the sensing circuit comprises:
a current mirroring circuit for decreasing the sensing current signal by a predetermined rate to output a ratio current from a current output node; and
a first resistance element coupled between the current output node and a first common voltage and generating the current sensing voltage based on the ratio current.

9. The power supply according to claim 8, wherein the controlling circuit is provided to output a control signal to control the conduction between the drain and the source terminals of the half high-voltage transistor, and the current mirroring circuit comprises:
a first transistor, the first source/drain terminal of the first transistor being coupled to the drain terminal of the half high-voltage transistor, the second source/drain terminal of the first transistor being coupled to the first common voltage, and the gate of the first transistor receiving the control signal;
an amplifier, a negative end thereof being coupled to the source terminal of the half high-voltage transistor;
a second transistor, the gate of the second transistor receiving a reverse control signal that reversed to the control signal, the first source/drain terminal of the second transistor being coupled to the negative end of the amplifier, and the second source/drain terminal of the second transistor being coupled to the first common voltage;
a third transistor, the gate of the third transistor receiving the reverse control signal, the first source/drain terminal of the third transistor being coupled to a positive end of the amplifier, and the second source/drain terminal being coupled to the first common voltage;
a forth transistor, the gate of the forth transistor receiving the control signal, the first source/drain terminal of the forth transistor being coupled to the positive end of the amplifier, and the second source/drain terminal of the forth transistor being coupled to the first common voltage;
a fifth transistor, the gate of the fifth transistor being coupled to an output end of the amplifier, the first source/drain terminal of the fifth transistor being coupled to a second common voltage, and the second source/drain terminal of the fifth transistor being coupled to the positive end of the amplifier; and
a sixth transistor, the gate of the sixth transistor being coupled to the output end of the amplifier, the first source/drain terminal of the sixth transistor being coupled to the second common voltage, and the second source/drain terminal of the sixth transistor being coupled to the current output node.

10. The power supply according to claim 9, wherein the current mirroring circuit further comprises a current source for outputting a bias current to the source terminal of the half high-voltage transistor.

11. The power supply according to claim 7, wherein a protection circuit for preventing a current of the source terminal of the half high-voltage transistor from being too high to damage the sensing circuit, is further provided between the half high-voltage transistor and the sensing circuit.

12. The power supply according to claim 11, wherein the protection circuit comprises:
a second resistance element, a first end of the second resistance element being coupled to the half high-voltage transistor, and a second end of the second resistance element being coupled to the sensing circuit; and
a third resistance element, a first end of the third resistance element being coupled to the second end of the second resistance element, and a second end of the third resistance element being coupled to a first common potential.

13. The power supply according to claim 7, wherein the magnetic element is an inductor or a transformer.
